(19) United States
(12) Patent Application Publication
(10) Pub. No.: US 2018/0343899 A1
(43) Pub. Date: Dec. 6, 2018

(54) NATURAL PRESERVATIVE COMPOSITIONS

(71) Applicant: ARIIX, LLC, Bountiful, UT (US)

(72) Inventors: Deanna Latson, Encinitas, CA (US); Tom Jackson, Murray, UT (US)

(21) Appl. No.: 15/994,429

(22) Filed: May 31, 2018

Related U.S. Application Data
(60) Provisional application No. 62/513,840, filed on Jun. 1, 2017.

(51) Int. Cl. A23L 3/3472; A23L 3/3562; A23L 2/02; A23L 2/44; A23L 29/30

(52) U.S. Cl. CPC A23L 3/3472; A23L 3/3562; A23L 2/02; A23L 2/44; A23V 2250/61; A23V 2002/00; A23V 2200/10; A23V 2250/5044; A23V 2250/5114; A23L 29/35

(57) ABSTRACT

A natural preservative composition for providing effective preservative effects to a food product, such as a fruit and/or vegetable juice product. The natural preservative composition includes a first component formed as a blend of fermented flax seed and/or fermented oregano, a second component formed as a blend of maltodextrin and/or fermented dextrose, and a third component formed as a blend of essential oils of culinary herbs.

### CROSS-REFERENCE TO RELATED APPLICATIONS

This application claims the benefit of and priority to U.S. Provisional Patent Application No. 62/513,840, filed on Jun. 1, 2017, the entirety of which is incorporated herein by this reference.

### BACKGROUND

Foods such as juices and other beverages are often formulated with additives to prevent spoilage. Typically, ingredients such as sodium or potassium benzoate and/or sodium or potassium sorbate are used. These preservatives are particularly prevalent in juices. While such preservatives have typically shown effectiveness for the purpose of extending food shelf life, concerns about health effects related to these non-natural preservatives have been increasing. In addition to such health related reasons, there are many who prefer (e.g., for lifestyle or other personal reasons) to purchase and consume foods that limit or eliminate such non-natural ingredients.

In lieu of these traditional preservatives, many products utilize ingredients considered to be more natural in order to reduce spoilage and extend the shelf life of the product. For example, it has long been known that high levels of salt, sugar, or organic acids such as acetic acid (e.g., vinegar) and citric acid can provide some degree of food preservation. However, these ingredients are not suitable for all types of food products, particularly at the levels required to provide a sufficient preservative effect. In addition, even when these types of ingredients are included, microbial growth (from bacteria, yeast, and/or mold) can still lead to reductions in shelf life and/or cause raise food safety/contamination concerns.

Juice products represent a particular challenge for natural preservative effectiveness. High levels of salt and sugar are typically undesirable and not suitable for juice products. Also, where some juice products naturally include organic acids and/or where such acids are added, the preservative effects are often not great enough to provide a product that is adequately safe and has adequate shelf life. Further, preservation challenges are compounded with juice products containing complex blends of many natural ingredients. While a diversity of natural ingredients can provide high levels of nutrients and corresponding health benefits for the juice consumer, it also correspondingly provides fertile ground for the growth and promulgation of bacteria, yeast, and mold.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

The present disclosure describes natural preservative compositions which may be added to one or more food products to provide beneficial preservative effects for to the food products. In certain embodiments, a natural preservative composition includes a first component formed as a blend of fermented flax seed and/or fermented oregano, a second component formed as a blend of maltodextrin and/or fermented dextrose, and a third component formed as a blend of essential oils of culinary herbs.

In preferred embodiments, the first component is a fermentation supernatant resulting from combined fermentation of both flaxseed and oregano and the second component includes both maltodextrin and cultured/fermented dextrose. In certain embodiments, the third component includes essential oils of anise and/or fennel.

In certain embodiments, the first component is added in an amount so as to make up about 1.0 to 4.0% of the total weight of the food product and preservative composition, or about 1.5 to 3.0% of the total weight of the food product and preservative composition, or more preferably about 2.0 to 2.5% of the total weight of the food product and preservative composition. In certain embodiments, the second component is added in an amount so as to make up about 0.1 to 2.0% of the total weight of the food product and preservative composition, or about 0.2 to 1.5% of the total weight of the food product and preservative composition, or more preferably about 0.5 to 0.7% of the total weight of the food product and preservative composition. In certain embodiments, the third component is added in an amount so as to make up about 0.02 to 0.5% of the total weight of the food product and preservative composition, or about 0.03 to 0.25% of the total weight of the food product and preservative composition, or more preferably about 0.05 to 0.1% of the total weight of the food product and preservative composition.

At least some of the embodiments described herein are able to provide broad-spectrum preservative activity for preventing the growth and promulgation of bacteria, yeast, and mold in food products to which they are added.

### DETAILED DESCRIPTION

Certain embodiments described herein are directed to compositions suitable for use as a food preservative, and in particular for use as a natural preservative for a juice product. Embodiments described herein have been shown to provide beneficial preservative effects when added to a juice blend by limiting the growth of bacteria, yeast, and mold for extended periods of time, thereby effectively extending the shelf life of the juice blend and rendering it safer for human consumption.

Throughout the description, exemplary embodiments are described in the context of preservatives for juice blends and other juice products. While such embodiments are presently preferred, one of skill in the art will understand that the preservative compositions described herein may be applied to and/or mixed within alternative food products (e.g., fruit or vegetable purees, concentrates, spreads) to provide similar beneficial preservative effects. Preservative composition embodiments described herein may be particularly useful for preserving food products that are based on natural ingredients and/or that omit traditional non-natural salt preservatives such as benzoates, sorbates, or other non-natural preservatives.

As used herein, the terms “natural,” “naturally sourced,” and the like are used to describe components/ingredients free of artificial ingredients and ingredients not typically found in large amounts in unprocessed foods. For example, preferred “natural” components used to formulate the natural preservative compositions are derived from plant sources and are subject to little or no additional processing. Suitable processing steps that can be utilized while still remaining within the scope of “natural” ingredients include fermentation processes, distillation processes (e.g., to extract essential oils from plant materials), physical processes (e.g., filtering, sieving, chopping, drying), and the like. In preferred embodiments, natural preservative compositions specifically exclude synthetically derived preservatives such as benzoates, sorbates, butylated hydroxyanisole, butylated hydroxyltoluene, nitrate or nitrite salts, sulfur dioxide, sulfites, or other such compounds not commonly found in high amounts in unprocessed foods, even if seen in trace amounts naturally in some foods (e.g., benzoates found in cranberries and some other plant foods).

Unless specifically described otherwise, concentrations and amounts of different components are given on a per weight basis relative to the total weight of the composition.

In some embodiments, a natural preservative composition includes: (1) a first component formed as a blend of fermented flax seed and/or fermented oregano, included in an amount so as to make up about 1.0 to 4.0% of the total weight of the combined food product and preservative composition; and (2) a second component formed as a blend of maltodextrin and/or fermented dextrose, included in an amount so as to make up about 0.1 to 2.0% of the total weight of the combined food product and preservative composition; and optionally (3) a third component formed as a blend of essential oils of culinary herbs, included in an amount so as to make up about 0.02 to 0.5% of the total weight of the combined food product and preservative composition.

In some embodiments, the first component is a fermentation supernatant resulting from fermentation of the flaxseed and/or oregano. In presently preferred embodiments, the first component is a fermentation supernatant resulting from the combined (i.e., same tank) fermentation of flaxseed and oregano. Fermentation is preferably carried out for more than 7 days, or more than 14 days, such as about 20 to 40 days or about 30 days. The first component may be added in an amount so as to make up about 1.0 to 4.0% of the total weight of the combined food product and preservative composition, or about 1.5 to 3.0% of the total weight of the combined food product and preservative composition, or more preferably about 2.0 to 2.5% of the total weight of the combined food product and preservative composition.

In some embodiments, the second component is a blend that includes both maltodextrin and fermented dextrose. The ratio of maltodextrin to fermented dextrose may be varied. For example, the ratio of maltodextrin to fermented dextrose may be about 8:1, 4:1, 2:1, 1:1, 0.5:1, 0.25:1, or 0.125 to 1. The second component may be added in an amount so as to make up about 0.1 to 2.0% of the total weight of the combined food product and preservative composition, or about 0.2 to 1.5% of the total weight of the combined food product and preservative composition, or more preferably about 0.5 to 0.7% of the total weight of the combined food product and preservative composition.

In some embodiments, the third component is added in an amount so as to make up about 0.02 to 0.5% of the total weight of the combined food product and preservative composition, or about 0.03 to 0.25% of the total weight of the combined food product and preservative composition, or more preferably about 0.05 to 0.1% of the total weight of the combined food product and preservative composition. The blend of essential oils of culinary herbs preferably includes essential oils of anise and/or fennel. One or more culinary herb essential oils may additionally or alternatively be included, such as essential oils of basil, rosemary, oregano, thyme, coriander, parsley, dill, mint, and the like.

It has been found that providing a preservative composition having components in amounts and proportions within the foregoing ranges beneficially results in a food product (e.g., a natural juice blend) with effective shelf life and resistance to microbial contamination. For example, a preservative composition as described herein may be capable of preventing microbial growth (including bacteria, yeast, and mold growth) for about 7 days or more, about 14 days or more, about 28 days or more, or even much longer periods of time. In some embodiments, the preservative composition reduces or eliminates microbial loads within the food product to acceptable food grade levels for a period of time sufficient to allow for transport and distribution to consumers, including typical consumer storage time (e.g., time spent within the consumer's refrigerator), without the food product experiencing spoiling and/or significant increases in microbial loads.

In some embodiments, the preservative composition provides broad-spectrum antimicrobial effects for preventing spoilage from bacteria, yeast, and mold. The separate components of the preservative compositions described herein have beneficially shown synergistic antimicrobial activity when combined with one another, enabling broad-spectrum antimicrobial activity and associated preservative effects not shown when individual components/ingredients are used independent from one another. For example, when the separate components are used independently, the resulting preservative effect may be less effective and in several instances, was unable to pass standardized preservative tests (i.e., the United States Pharmacopeia chapter <51> Preservative Challenge Test (using the test as standardized as of June 2017)). In contrast, preservative compositions as described herein which include a combination of the separately described components have shown broad-spectrum preservative effects enabling the composition to pass such standardized preservative tests.

In at least some implementations, a preservative composition as described herein may be added to a food product without altering the pH of the food product to a detrimental degree. For example, where a food product has an acidic baseline pH (as is the case in many juice or other fruit and/or vegetable based products), some preservative formulations of the prior art may cause the pH of the food product to increase to a level closer to neutral pH. This pH increase can reduce the ability to control microbial growth. In particular, mold growth can become significantly more difficult to control as the pH is raised closer to a neutral level. Such preservative formulations therefore work against the overall goal of preserving the food product from all forms of microbial contamination, even if they may be effective against a subset of the common microbial contaminants (such as bacteria and/or non-mold yeasts). In contrast, preservative compositions as described herein are capable of providing broad-spectrum preservative effects without detrimentally promoting the growth of one or more microbial forms, such as mold.

In some implementations, even where a pH increase results from the addition of a natural preservative composition, the synergistic effects of the combined components of the preservative composition function to prevent the pH increase from detrimentally resulting in failure of the preservative. For example, even if the pH level is raised by some degree, the broad-spectrum capabilities of the preservative composition have been shown to effectively prevent microbial growth, including preventing the growth of mold (which is often the initial culprit when a rise in pH has occurred). Accordingly, where other preservative formulations may fail as a result of increases to the pH of the associated food product, a natural preservative composition as described herein may function to reduce or eliminate detrimental effects associated with pH rise.

A method for preserving a food product using a natural preservative composition includes: (1) providing a food product; (2) adding a natural preservative composition to the food product; and (3) the natural preservative composition preserving the food product. Preservation of the food product may be shown as an extension of the shelf life of the food product relative to a similar food product not including the natural preservative composition. Additionally, or alternatively, a preservation effect may be shown as an improvement in the performance of the food product and natural preservative composition in one or more standardized preservative challenge tests relative to performance of a similar food product omitting the natural preservative composition but otherwise provided under similar conditions.

In presently preferred embodiments, the food product is a fruit and/or vegetable based product, such as a juice, puree, concentrate, or the like. As explained by the foregoing, the natural preservative composition includes a combination of separate components which work synergistically when combined to provide broad-spectrum activity to limit growth and promulgation of bacteria, yeast, and mold for extended periods of time (e.g., for periods of at least 28 days). In at least some implementations, the preservative effect of the natural preservative composition is enhanced by the synergistic relationship between the separate components of the natural preservative composition.

In some embodiments, the fruit and/or vegetable product is provided at an initial pH level of about 2.6 to 4.5, or about 2.8 to 4.0, or about 3.0 to 3.5. In at least some implementations, a natural preservative composition as described herein may be added to the fruit and/or vegetable product without significantly changing or affecting the initial pH. For example, after addition of the natural preservative composition, the pH may be maintained below about 6.0, or below about 5.5, or below about 5.0, or below about 4.5, or below about 4.0.

As used herein, the terms “approximately,” “about,” and “substantially” as used herein represent an amount or condition close to the stated amount or condition that still performs a desired function or achieves a desired result. For example, the terms “approximately,” “about,” and “substantially” may refer to an amount or condition that deviates by less than 10%, or by less than 5%, or by less than 1%, or by less than 0.1%, or by less than 0.01% from a stated amount or condition.

### EXAMPLES

### Example 1

Three separate preservative treatments were added to a juice blend including over 20 different plant ingredients. The components (in weight percentages of the total juice blend) of each treatment are shown in Table 1. The “essential oil blend” was a blend of essential oils of culinary herbs, including essential oils of anise and fennel. Treatment 1 was a positive control (potassium benzoate and potassium sorbate added).

TABLE 1

| | Treatment 1 | Treatment 2 | Treatment 3 |
|---|---|---|---|
| Potassium | 0.15 | 0 | 0 |
| benzoate | | | |
| Potassium | 0.04 | 0 | 0 |
| sorbate | | | |
| Essential oil | 0.10 | 0.20 | 0.20 |
| blend | | | |

The juice blends were subjected to an antimicrobial preservative effectiveness test (United States Pharmacopeia 39, <51>) (2017). Treatments 2 and 3 showed excessive microbial growth and failed the test at the 7 day time point.

### Example 2

Four additional preservative treatments (Treatments 4 through 7) were added to a juice blend similar to that used in Example 1. The components of each treatment are shown in Table 2. The “essential oil blend” was the same blend utilized in Example 1. The “cultured dextrose blend” was a blend of maltodextrin and fermented dextrose. The “cultured dextrose blend+” was a blend of maltodextrin, fermented dextrose, mustard essential oil, green tea extract, and α-cyclodextrin.

TABLE 2

| | Treatment 4 | Treatment 5 | Treatment 6 | Treatment 7 |
|---|---|---|---|---|
| Potassium | 0 | 0 | 0 | 0 |
| benzoate | | | | |
| Potassium | 0 | 0 | 0 | 0 |
| sorbate | | | | |
| Essential oil | 0.10 | 0.10 | 0.10 | 0.10 |
| blend | | | | |
| Cultured | 0.50 | 0.50 | 0.50 | 1.00 |
| dextrose blend | | | | |
| Cultured | 0.50 | 0.75 | 1.00 | 0 |
| dextrose blend+ | | | | |

The juice blends were subjected to an antimicrobial preservative effectiveness test as in Example 1. All treatments failed the test by the 7 day time point. Treatments 4 through 6 also experienced an increase in pH levels, suggesting that the “cultured dextrose blend+component” included in treatments 4 through 6 was the cause of the pH drift.

### Example 3

Five additional preservative treatments (Treatments 8 through 12) were added to a juice blend similar to that used in Examples 1 and 2. The components of each preservative treatment are shown in Table 3. The “essential oil blend,” “cultured dextrose blend,” and “cultured dextrose blend+” components were the same blends as in the previous Examples. The “fermented flax/oregano” component was a fermentation supernatant resulting from fermentation of a combined mass of flaxseed and oregano. Treatment 9 was a negative control (no preservative added). Treatment 10 was a positive control (potassium sorbate added).

TABLE 3

| | | Treatment | Treatment | | |
|---|---|---|---|---|---|
| | | 9 | 10 | | |
| | Treatment | (negative | (positive | Treatment | Treatment |
| | 8 | control) | control) | 11 | 12 |
| Potassium | 0 | 0 | 0 | 0 | 0 |
| benzoate | | | | | |
| Potassium | 0 | 0 | 0.04 | 0 | 0 |
| sorbate | | | | | |
| Essential oil | 0.10 | 0.10 | 0.10 | 0.10 | 0.10 |
| blend | | | | | |
| Cultured | 0.50 | 0 | 0 | 1.00 | 0 |
| dextrose | | | | | |
| blend | | | | | |
| Cultured | 0 | 0 | 1.50 | 1.50 | 1.50 |
| dextrose | | | | | |
| blend+ | | | | | |
| Citric acid | q.s. to pH | q.s. to pH | 0 | q.s. to pH | q.s. to pH |
| | 3.0 | 3.0 | | 3.0 | 3.0 |
| Fermented | 2.00 | 0 | 0 | 0 | 0 |
| flax/oregano | | | | | |
| Oregano | 0 | 0 | 0 | 0 | 1.00 |
| extract | | | | | |

The juice blends were subjected to an antimicrobial preservative effectiveness test as in the previous Examples. The results for each of Treatments 8 through 12 are shown in Tables 4 through 8, respectively. Values listed in the following tables represent colony forming units per gram.

TABLE 4
Preservative Efficacy Test for Treatment 8

| Test | | P. | | | A. |
|---|---|---|---|---|---|
| Interval | E. coli | aeuruginosa | S. aureus | C. albicans | brasiliensis |
| 0 hours | 35,000 | <100 | 120,000 | 226,000 | 220,000 |
| 7 days | <10 | <10 | <10 | <10 | 150 |
| 14 days | <10 | <10 | <10 | <10 | <10 |
| 28 days | <10 | <10 | <10 | <10 | <10 |

TABLE 5
Preservative Efficacy Test for Treatment 9 (negative control)

| Test | | P. | | | A. |
|---|---|---|---|---|---|
| Interval | E. coli | aeuruginosa | S. aureus | C. albicans | brasiliensis |
| 0 hours | 149,000 | 100 | 176,000 | 400,000 | 230,000 |
| 7 days | <10 | <10 | <10 | >30,000 | 19,800 |
| 14 days | 178,000 | <10 | <10 | >300,000 | 22,000 |
| 28 days | >300,000 | <10 | <10 | 9,400,000 | 64,000 |

TABLE 6
Preservative Efficacy Test for Treatment 10 (positive control)

| Test | | P. | | | A. |
|---|---|---|---|---|---|
| Interval | E. coli | aeuruginosa | S. aureus | C. albicans | brasiliensis |
| 0 hours | 146,000 | <100 | 138,000 | 400,000 | 230,000 |
| 7 days | <10 | <10 | <10 | <10 | 90 |
| 14 days | <10 | <10 | <10 | <10 | <10 |
| 28 days | <10 | <10 | <10 | <10 | <10 |

TABLE 7
Preservative Efficacy Test for Treatment 11

| Test | | P. | | | A. |
|---|---|---|---|---|---|
| Interval | E. coli | aeuruginosa | S. aureus | C. albicans | brasiliensis |
| 0 hours | 140,000 | <100 | 137,000 | 250,000 | 240,000 |
| 7 days | <10 | <10 | <10 | <10 | 140 |
| 14 days | <10 | <10 | <10 | <10 | <10 |
| 28 days | <10 | <10 | <10 | <10 | 1000 |

TABLE 8
Preservative Efficacy Test for Treatment 12

| Test | | P. | | | A. |
|---|---|---|---|---|---|
| Interval | E. coli | aeuruginosa | S. aureus | C. albicans | brasiliensis |
| 0 hours | 14,100 | <100 | 340,000 | 310,000 | 410,000 |
| 7 days | <10 | <10 | <10 | 1,470 | 400 |
| 14 days | <10 | <10 | <10 | <10 | <10 |
| 28 days | <10 | <10 | <10 | <10 | <10 |

For a Category 3 product (oral products other than antacids) to pass the USP <51> efficacy test, there must be greater than or equal to 90.0% reduction in bacteria from the initial count at 14 days, no increase in bacteria between the 14 and 28 day time points, and no increase of yeasts or molds from initial counts. Treatments 8, 10, and 12 fulfilled these requirements. Treatment 10 was the positive control. Treatment 8 was particularly effective (on par with the positive control), and worked faster than treatment 12 in reducing yeast and mold levels.

### Example 4

Treatment 8 was again subjected to an antimicrobial preservative effectiveness test as in the previous Examples. Results of the test are shown in Table 9. Samples were only taken at the 14 and 28 day time points. As before, Treatment 8 passed the efficacy test for a Category 3 product.

TABLE 9
Second Preservative Efficacy Test for Treatment 8

| Test | | P. | | | A. |
|---|---|---|---|---|---|
| Interval | E. coli | aeuruginosa | S. aureus | C. albicans | brasiliensis |
| 0 hours | 690,000 | 420,000 | 1,200,000 | 190,000 | 200,000 |
| 14 days | <10 | <10 | <10 | <10 | <10 |
| 28 days | <10 | <10 | <10 | <10 | <10 |

What is claimed is:

1. A natural preservative composition for adding to a food product, comprising:
a first component formed as a blend of fermented flax seed and/or fermented oregano;
a second component formed as a blend of maltodextrin and/or fermented dextrose; and
a third component formed as a blend of essential oils of culinary herbs.

2. The preservative composition of claim 1, wherein the first component is included in an amount so as to make up about 1.0 to 4.0% of the total weight of the combined food product and preservative composition.

3. The preservative composition of claim 1, wherein the first component is added in amount so as to make up about 1.5 to 3.0% of the total weight of the combined food product and preservative composition.

4. The preservative composition of claim 1, wherein the first component is added in amount so as to make up about 2.0 to 2.5% of the total weight of the combined food product and preservative composition.

5. The preservative composition of any claim 1, wherein the second component is included in an amount so as to make up about 0.1 to 2.0% of the total weight of the combined food product and preservative composition.

6. The preservative composition of claim 1, wherein the second component is added in an amount so as to make up about 0.2 to 1.5% of the total weight of the combined food product and preservative composition.

7. The preservative composition of claim 1, wherein the second component is added in an amount so as to make up about 0.5 to 0.7% of the total weight of the combined food product and preservative composition.

8. The preservative composition of claim 1, wherein the third component is included in an amount so as to make up about 0.02 to 0.5% of the total weight of the combined food product and preservative composition.

9. The preservative composition of claim 1, wherein the third component is included in an amount so as to make up about 0.03 to 0.25% of the total weight of the combined food product and preservative composition.

10. The preservative composition of claim 1, wherein the third component is included in an amount so as to make up about 0.05 to 0.1% of the total weight of the combined food product and preservative composition.

11. The preservative composition of claim 1, wherein the first component is a fermentation supernatant resulting from fermentation of the flaxseed and/or oregano.

12. The preservative composition of claim 11, wherein the fermentation supernatant results from the combined fermentation of both flaxseed and oregano.

13. The preservative composition of claim 1, wherein the second component includes both maltodextrin and fermented dextrose.

14. The preservative composition of claim 13, wherein the ratio of maltodextrin to fermented dextrose is in a range of about 8:1 to about 0.125:1.

15. The preservative composition of claim 1, wherein the third component includes essential oils of anise and/or fennel.

16. The preservative composition of claim 1, wherein the preservative composition provides broad-spectrum antimicrobial effects for preventing spoilage from bacteria, yeast, and mold.

17. A fruit and/or vegetable based product having effective preservative properties, the product comprising:
one or more fruit and/or vegetable based ingredients; and
a natural preservative composition as in claim 1.

18. The product of claim 17, wherein the product is a juice.

19. A method for preserving a food product using a natural preservative composition, the method comprising:
providing a food product;
adding a natural food preservative composition to the food product, the natural preservative composition including
a first component formed as a blend of fermented flax seed and/or fermented oregano;
a second component formed as a blend of maltodextrin and/or fermented dextrose; and
a third component formed as a blend of essential oils of culinary herbs; and
the natural preservative composition preserving the food product.

20. The method of claim 19, wherein the food product is a fruit and/or vegetable based juice product, and wherein the natural preservative composition prevents microbial growth for at least 28 days.
